(19) United States
(12) Patent Application Publication
(10) Pub. No.: US 2018/0329366 A1
(43) Pub. Date: Nov. 15, 2018

(54) IMAGE REPRODUCTION DEVICE, IMAGE REPRODUCTION METHOD, AND DIGITAL HOLOGRAPHY DEVICE

(71) Applicant: The School Corporation Kansai University, Osaka (JP)

(72) Inventor: Tatsuki Tahara, Osaka (JP)

(21) Appl. No.: 15/754,228

(22) PCT Filed: Oct. 11, 2016
(86) PCT No.: PCT/JP2016/080095

§ 371 Date: Feb. 21, 2018

(30) Foreign Application Priority Data
Oct. 13, 2015 (JP) 2015-201996

(51) Int. Cl. G03H 1/22; G03H 1/04

(52) U.S. Cl. CPC G03H 1/2294; G03H 2226/02; G03H 1/0443

(57) ABSTRACT

Proposed are an image reproduction device, an image reproduction method, and a digital holography device, by which the calculation load is reduced and a time required to reproduce an object image from hologram image data is shortened, compared with a conventional technology. An image reproduction device (17) can reproduce an object image or a phase image thereof from hologram image data without performing conventional two-dimensional Fourier transform or two-dimensional inverse Fourier transform. Since no two-dimensional Fourier transform or no two-dimensional inverse Fourier transform is performed, the calculation load can be accordingly reduced, and a time required to reproduce an object image from hologram image data can be accordingly shortened, compared with a conventional technology.

### TECHNICAL FIELD

The present invention relates to an image reproduction device, an image reproduction method, and a digital holography device.

### BACKGROUND ART

Attention has been recently paid to a digital holography technique for reproducing, by use of a computer, an image of a three-dimensional object from an interference pattern that is obtained by irradiation of the three-dimensional object with light. In practice, a digital holography device using such a digital holography technique is capable of capturing, by means of an imaging element such as a CCD (charge-coupled device), an image of an interference pattern (interference fringes) generated by object light from an object and reference light, and of recording the image as hologram image data.

As illustrated in FIG. 13, a hologram image 100 obtained on the basis of hologram image data is formed of a prescribed interference pattern, and an image of an object can be reproduced by an image reproduction process (see Patent Document 1, for example). In this case, in the image reproduction process, the digital holography device first performs two-dimensional Fourier transform on the hologram image data, and thereby obtains spatial frequency distribution data. Here, wavelengths (for example, a wavelength λ₁₀₁, a wavelength λ₁₀₂, a wavelength λ₁₀₃) according to an interval between interference fringes, spatial spectra ER₁₀₁, ER₁₀₂. ER₁₀₃ of object light according to a reference-light irradiation angle with respect to the imaging element, and the like, appear in a spatial frequency distribution image 101 obtained on the basis of the spatial frequency distribution data. In the spatial frequency distribution image 101, Vₓ represents the spatial frequency on the abscissa and V_{y} represents the spatial frequency on the ordinate.

The digital holography device extracts the spatial spectra ER₁₀₁, ER₁₀₂, ER₁₀₃ from the spatial frequency distribution data, and, for example, performs two-dimensional inverse Fourier transform on the extracted spatial spectra ER₁₀₁, ER₁₀₂, ER₁₀₃ for the wavelengths λ₁₀₁, λ₁₀₂, λ₁₀₃, so that hologram reproduction image data can be generated for each of the wavelengths λ₁₀₁, λ₁₀₂, λ₁₀₃. Here, the digital holography device obtains hologram reproduction images 111, 112, 113 based on the hologram reproduction image data obtained for each of the wavelengths λ₁₀₁, λ₁₀₂, λ₁₀₃, respectively, and suppresses noise, which is called a speckle, in the reproduction images by smoothing the hologram reproduction images 111, 112, 113, so that hologram reproduction images 121, 122, 123 which have undergone correction for the wavelengths λ₁₀₁, λ₁₀₂, λ₁₀₃, can be obtained. In addition, the digital holography device can also obtain phase images 131, 132, 133 indicating the object height (depth dimension) distribution (in which a brighter portion is higher (on the front side), and a darker portion is lower (on the rear side)) based on the hologram reproduction image data.

### CITATION LIST

### Patent Literature

Patent Document 1

Japanese Patent Laid-Open No. 2015-064565

### SUMMARY OF INVENTION

### Technical Problem

However, when reproducing hologram image data, such a conventional digital holography device performs two-dimensional Fourier transform on the hologram image data one time, and performs two-dimensional inverse Fourier transform a number of times according to the number of extracted wavelengths, so that the calculation load is large. Accordingly, a certain time is disadvantageously required to reproduce an image of an object from hologram image data.

Therefore, the present invention has been made in view of the above problems, and an object of the present invention is to provide an image reproduction device, an image reproduction method, and a digital holography device, by which calculation loads can be reduced and a time required to reproduce an image of an object from hologram image data can be shortened, compared with the conventional technique.

### Solution to Problem

In order to solve the aforementioned problems, an image reproduction device according to the present invention reproduces hologram image data formed of object light from an object and of reference light applied at a prescribed angle with respect to the object light. The device is characterized by including a calculation unit that generates spatial carrier-eliminated image data by eliminating a spatial carrier component, which is generated due to a phase distribution of the reference light and which phase-modulates the object light, from the hologram image data through calculation, and a reproduction image generation unit that generates hologram reproduction image data by replacing one or more target pixels included in the spatial carrier-eliminated image data respectively with high frequency component-eliminated pixels obtained by average value conversion or weighting using of a prescribed number of pixels.

Furthermore, an image reproduction method according to the present invention is for reproducing hologram image data formed of object light from an object and of reference light applied at a prescribed angle with respect to the object light. The method is characterized by including a calculation step of generating spatial carrier-eliminated image data by eliminating a spatial carrier component, which is generated due to a phase distribution of the reference light and which phase-modulates the object light, from the hologram image data through calculation that is executed by a calculation unit, and a reproduction image generating step of generating hologram reproduction image data by replacing, by means of a reproduction image generation unit, one or more target pixels included in the spatial carrier-eliminated image data with high frequency component-eliminated pixels obtained by average value conversion or weighting using a prescribed number of pixels.

Moreover, a digital holography device according to the present invention records, as hologram image data, an interference pattern that is formed of object light from an object and of reference light applied at a prescribed angle with respect to the object light by means of an imaging element, the interference pattern being obtained by applying the object light and the reference light to an image capturing surface of the imaging element. The digital holography device is characterized in that the imaging element transmits the hologram image data to the aforementioned image reproduction device.

### Advantage Effects of Invention

According to the present invention, an object image or a phase image thereof can be reproduced from hologram image data at least without conventional two-dimensional inverse Fourier transform. Thus, two-dimensional inverse Fourier transform is not performed, and accordingly, the calculation load can be reduced and a time required to reproduce an image of an object from hologram image data can be shortened, compared with a conventional technology.

### BRIEF DESCRIPTION OF DRAWINGS

FIG. 1 is a schematic diagram illustrating a configuration of a digital holography device provided with an image reproduction device according to the present invention;

FIG. 2 is a schematic diagram illustrating a circuit configuration of the image reproduction device;

FIG. 3 is a flowchart showing an image reproduction procedure;

FIG. 4A shows one example of a hologram image, and FIG. 4B is an image indicating a height distribution of an object in the hologram image shown in FIG. 4A;

FIG. 5A is a spatial frequency distribution image obtained before a spatial carrier is eliminated from hologram image data, and FIG. 5B is a spatial frequency distribution image obtained after a spatial carrier is eliminated from the hologram image data;

FIG. 6A is a schematic diagram showing a configuration of a spatial carrier-eliminated image, FIG. 6B is a schematic diagram showing the configuration of a hologram reproduction image generated from the spatial carrier-eliminated image in FIG. 6A through an average value process, and FIG. 6C is a schematic diagram showing a configuration of another hologram reproduction image generated from the hologram reproduction image in FIG. 6B through the additional average value process;

FIG. 7A is a simulation image showing a red image of an object used in simulation, FIG. 7B is a simulation image showing a green image of the object used in the simulation, FIG. 7C is a simulation image showing a blue image of the object used in the simulation, and FIG. 7D is an image indicating the height distribution of the object used in the simulation;

FIG. 8A is an image showing a red image obtained by executing the average value process five times, FIG. 8B is an image showing a green image obtained by executing the average value process five times, FIG. 8C is an image showing a blue image obtained by executing the average value process five times, FIG. 8D is an image indicating the height distribution of the object image in FIG. 8A, FIG. 8E is an image indicating the height distribution of the object image in FIG. 8B, and FIG. 8F is an image indicating the height distribution of the object image in FIG. 8C;

FIG. 9A is a red image obtained by executing the average value process ten times, FIG. 9B is a green image obtained by executing the average value process ten times, FIG. 9C is a blue image obtained by executing the average value process ten times, FIG. 9D is an image indicating the height distribution of the object image in FIG. 9A, FIG. 9E is an image indicating the height distribution of the object image in FIG. 9B, and FIG. 9F is an image indicating the height distribution of the object image in FIG. 9C;

FIG. 10A is a simulation image obtained by synthesizing FIGS. 7A to 7C, FIG. 10B is an image obtained by synthesizing FIGS. 8A to 8C, and FIG. 100 is an image obtained by synthesizing FIGS. 9A to 9C;

FIG. 11A is a spatial frequency distribution image obtained by executing the average value process five times, FIG. 11B is an RGB image obtained by executing the average value process five times, FIG. 11C is an image indicating the height distribution of the object image in FIG. 11B, FIG. 11D is a spatial frequency distribution image obtained by executing the average value process seven times, FIG. 11E is an RGB image obtained by executing the average value process seven times, FIG. 11F is an image indicating the height distribution of the object image in FIG. 11E, FIG. 11G is a spatial frequency distribution image obtained by executing the average value process ten times, FIG. 11H is an RGB image obtained by executing the average value process ten times, and FIG. 11I is an image indicating the height distribution of the object image in FIG. 11H;

FIG. 12 is a schematic diagram illustrating a circuit configuration of an image reproduction device according to another embodiment; and

FIG. 13 is a schematic diagram for an explanation of a conventional image reproduction process using hologram image data.

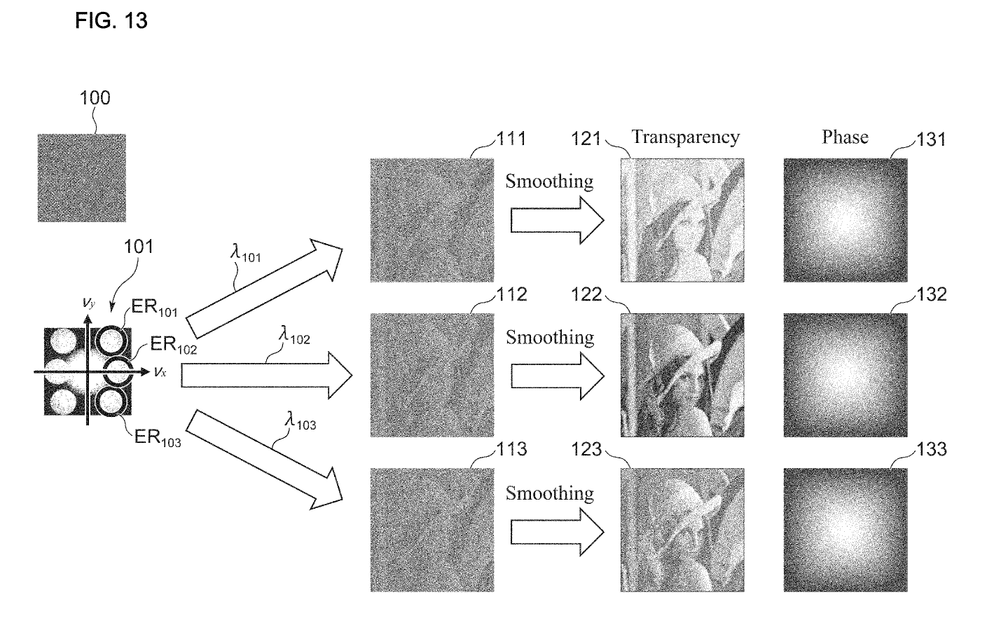

### DESCRIPTION OF EMBODIMENTS

Hereinafter, an embodiment of the present invention is described in detail with reference to the drawings.

### (1) Configuration of Digital Holography Device

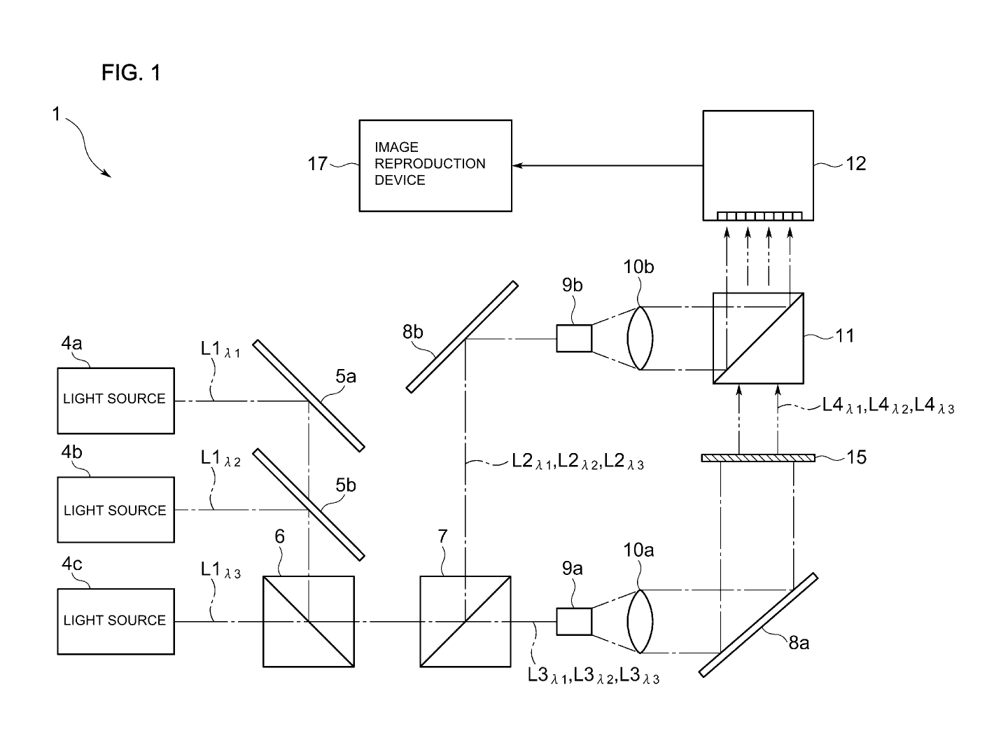

FIG. 1 illustrates one example of a digital holography device 1 provided with an image reproduction device 17 according to the present invention. Note that, in the present embodiment, the digital holography device 1 is described in which light sources 4a, 4b, 4c emit laser lights L1_{λ1}, L1_{λ2}, L1_{λ3} of different wavelengths, respectively, and the laser lights L1_{λ1}, L1_{λ2}, L1_{λ3} of three wavelengths are used. However, the present invention is not limited to the digital holography device 1. Alternatively, a digital holography device in which laser lights of four or more wavelengths, one wavelength, or two wavelengths are emitted, may be used.

In this case, in the digital holography device 1, the laser lights L1_{λ1}, L1_{λ2} emitted from the light sources 4a, 4b are reflected by mirrors 5a, 5b so as to be applied to a beam coupling element 6, while a laser light L1_{λ3} emitted from the light source 4c is applied to the beam coupling element 6. The laser lights L1_{λ1}, L1_{λ2}, L1_{λ3} are applied to a beam splitting element 7 from the beam coupling element 6, and are split into reference lights L2_{λ1}, L2_{λ2}, L2_{λ3} and objection irradiating lights L3_{λ1}, L3_{λ2}, L3_{λ3} by the beam splitting element 7.

The object irradiating lights L3_{λ1}, L3_{λ2}, L3_{λ3} transmitted through the beam splitting element 7 are transmitted through a beam expander 9a and a collimator lens 10a sequentially, are reflected by a mirror 8a, and are applied to an object 15. Object lights L4_{λ1}, L4_{λ2}, L4_{λ3} obtained from the object 15 upon irradiation with the object irradiating lights L3_{λd}, L3_{λ2}, L3_{λ3}, are transmitted through a beam coupling element 11, and reach an image capturing surface of an imaging element 12.

On the other hand, the reference lights L2_{λ1}, L2_{λ2}, L2_{λ3} reflected by the beam splitting element 7 are reflected by a mirror 8b, are transmitted through a beam expander 9b and a collimator lens 10b sequentially, and are applied to the beam coupling element 11. The reference lights L2_{λ1}, L2_{λ2}, L2_{λ3} are reflected by the beam coupling element 11 toward the imaging element 12, and reach the image capturing surface of the imaging element 12. An interference pattern is formed, on the image capturing surface, by interference between the object lights L4_{λ1}, L4_{λ2}, L4_{λ3} of the wavelengths λ1, λ2, λ3 and the reference lights L2_{λ1}, L2_{λ2}, L2_{λ3} of the wavelengths λ1, λ2, λ3 applied at a prescribed angle with respect to the object lights L4_{λ1}, L4_{λ2}, L4_{λ3}. The imaging element 12 records hologram image data obtained by capturing an image of the interference pattern, and sends the hologram image data to an image reproduction device 17.

The image reproduction device 17 acquires the hologram image data from the imaging element 12, and executes an image reproduction process (described later) on the hologram image data, so that an image of the object or a phase image indicating a height distribution of the object can be reproduced on the basis of the hologram image data without conventional two-dimensional Fourier transform or two-dimensional inverse Fourier transform.

### (2) Image Reproduction Device According to Present Invention

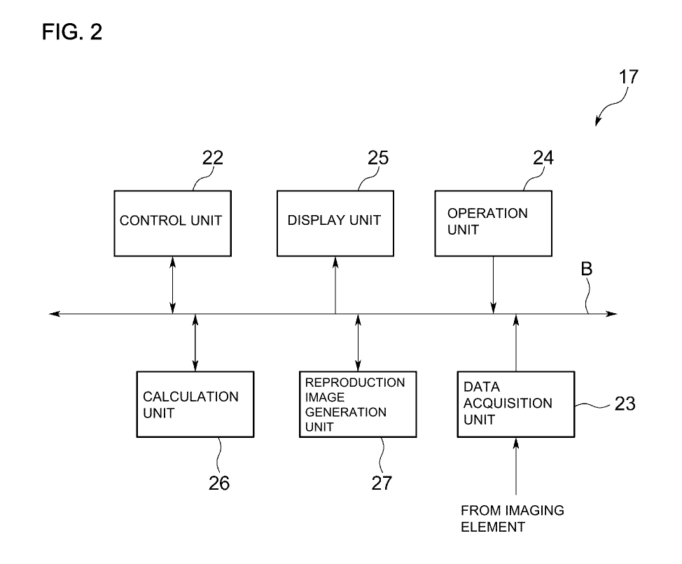

Here, the image reproduction device 17 according to the present invention has a configuration in which a control unit 22 having a microcomputer configuration formed of a CPU (central processing unit), a ROM (read only memory), a RAM (random access memory), and the like, which are not illustrated, a data acquisition unit 23 that acquires hologram image data from an imaging element, an operation unit 24 that receives inputs of various operation instructions, a display unit 25 that displays various images, a calculation unit 26 that executes a spatial carrier elimination process (described later) during an image reproduction process, and a reproduction image generation unit 27 that executes an average value process (described later) during the image reproduction process, are connected to one another via a bus B, as illustrated in FIG. 2.

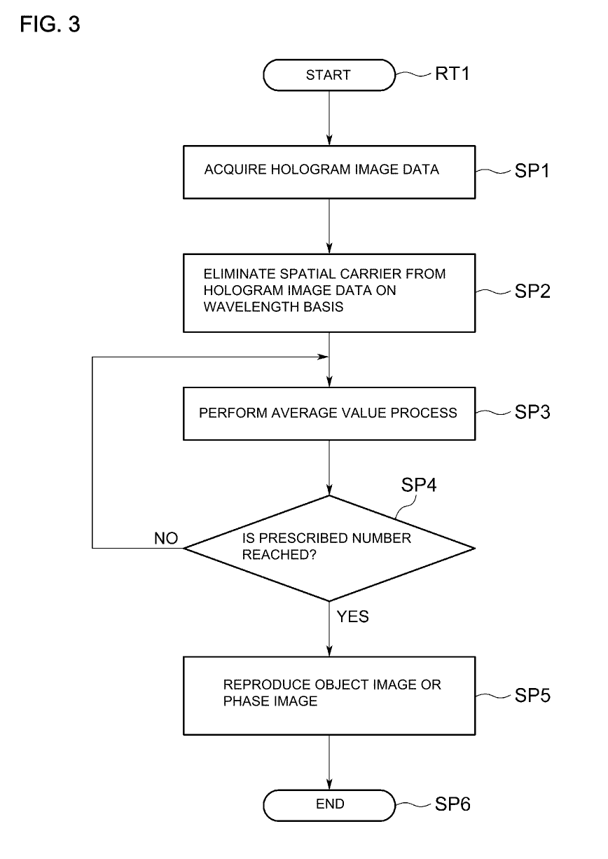

The control unit 22 loads, into the RAM, an image reproduction process program stored in advance in the ROM and starts the program so as to collectively controls various functions of the image reproduction device 17. The control unit 22 is configured to be able to, by using hologram image data acquired through a data acquisition unit 23, generate hologram reproduction image data through the calculation unit 26 and the reproduction image generation unit 27, and cause the display unit 25 to display an object image and a phase image indicating a height distribution of the object which are generated on the basis of the hologram reproduction image data. In this case, when detecting that an image reproduction operation has been performed on the operation unit 24, the control unit 22 starts an image reproduction process procedure RT1 shown in FIG. 3 in accordance with the image reproduction process program.

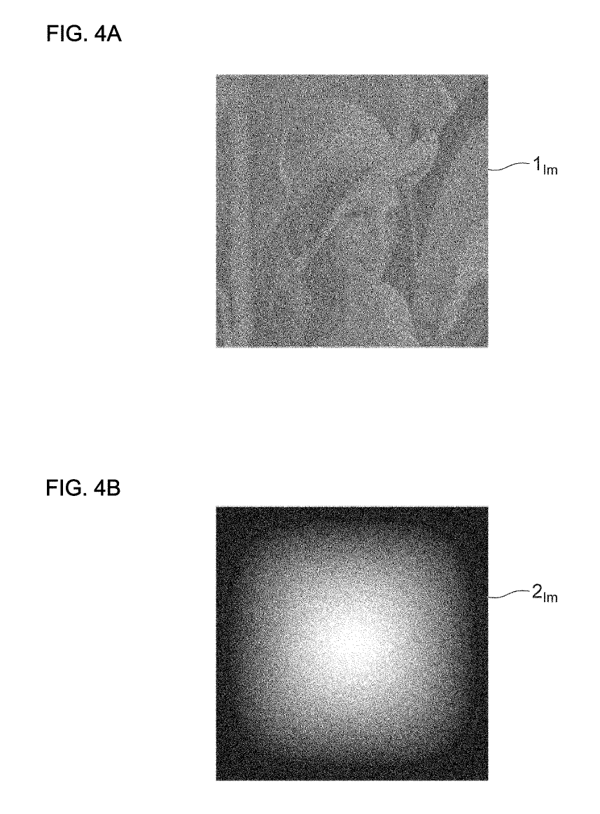

After starting the image reproduction process procedure RT1, the control unit 22 acquires hologram image data from the imaging element 12 through the data acquisition unit 23 at step SP1, and the procedure proceeds to next step SP2. Here, the hologram image data is obtained by multiple-recording information about three single-plate and single-color wavelengths in the imaging element 12, for example. The hologram image data is displayed as a hologram image 1_{Im} expressed by an interference pattern, as shown in FIG. 4A. FIG. 4B is an image 2₁ₘ indicating a phase distribution of object light in the hologram image 1_{Im} shown in FIG. 4A. The image 2_{Im} indicates the height of the object in bright-dark gradation on a height basis in terms of the wavelength of one laser light.

Next, as shown in FIG. 3, the calculation unit 26 executes the spatial carrier eliminating process at step SP2 so as to eliminate a spatial carrier for each wavelength from the hologram image data through calculation, and thereby generates spatial carrier-eliminated image data. Here, the spatial carrier eliminating process is described in detail. In this case, a complex amplitude distribution Uₒ(x, y) of an object light at the position (x, y) on the image capturing surface of the imaging element 12 is expressed by Expression 1, and a complex amplitude distribution Uᵣ(x, y) of a reference light at the position (x, y) on the image capturing surface of the imaging element 12 is expressed by Expression 2. Note that Aₒ represents the amplitude of object light, ϕₒ represents the phase of object light, ϕᵣ represents the amplitude of reference light, Oᵣ represents the phase of reference light, i represents an imaginary unit, and (x, y) represents the position on the x-y plane corresponding to the image capturing surface.

Uₒ(x,y)=Aₒ(x,y)exp{iϕₒ(x,y)} [Expression 1]

Uᵣ(x,y)=Aᵣ(x,y)exp{iϕᵣ(x,y)} [Expression 1]

Further, when the hologram image data is defined as H(x, y) and a light intensity distribution at each wavelength λ is defined as I(x, y), H(x, y) and I(x, y) are expressed by Expressions 3 and 4, respectively. Note that I_{λ} (x, y) represents a light intensity distribution at a wavelength λ, and * represents a complex conjugate.

$$\begin{matrix}H ( x , y ) = {I}_{λ 1} ( x , y ) + {I}_{λ 2} ( x , y ) + {I}_{λ 3} ( x , y ) & [ Expression 3 ] \\ \begin{matrix}I ( x , y ) = {\vert {U}_{o} ( x , y ) \vert}^{2} + {\vert {U}_{r} ( x , y ) \vert}^{2} + \\ {U}_{o} ( x , y ) {{U}_{r} ( x , y )}^{*} + {{U}_{o} ( x , y )}^{*} {U}_{r} ( x , y ) \\ = {{A}_{o} ( x , y )}^{2} + {{A}_{r} ( x , y )}^{2} + \\ 2 {A}_{o} ( x , y ) {A}_{r} ( x , y ) cos \{ {φ}_{o} ( x , y ) - {φ}_{r} ( x , y ) \}\end{matrix} & [ Expression 4 ]\end{matrix}$$

From an expression

Aₒ(x,y)²+Aᵣ(x,y)²+2Aₒ(x,y)Aᵣ(x,y)cos {ϕₒ(x,y)−ϕᵣ(x,y)}

(hereinafter, also referred to as a second expression) in the lower line of Expression 4, it is indicated that how minute the fringes are depends on whether a phase change in the reference light on the x-y plane is slow or fast.

In an expression

|Uₒ(x,y)|²+|Uᵣ(x,y)|²+Uₒ(x,y)*Uᵣ(x, y)*+Uₒ(x, y)*Uᵣ(x, y)

(hereinafter, also referred to as a first expression) in the upper line of Expression 4, Uₒ(x,y)Uᵣ(x,y)* in a third term of the right side represents an object image, which is desired information, and it is indicated that modulation by the term Uᵣ* is performed thereon. In other words, a spatial carrier (a spatial carrier component) of the phase term of Uᵣ* can be considered to modulate the Uₒ(x,y). Here, the spatial carrier component is generated on the basis of the phase distribution (also referred to as a phase term) of Uᵣ(x,y)*, and Uᵣ(x,y)*=Aᵣ(x,y)exp{−iϕᵣ(x,y)} is established. Thus, the spatial carrier component corresponds to exp{−iϕᵣ(x,y)}.

Whether a change of the phase distribution is slow or fast is determined mainly by the inclination angle of reference light. The inclination angle of reference light can be adjusted at a stage of designing the optical system (the configuration from the light sources 4a, 4b, 4c to the beam coupling element 11) of the digital holography device 1, or can be set to a desired value by the subsequent adjustment of the optical system. Thus, the inclination angle can be regarded as known information. Therefore, in the image reproduction device 17, the phase distribution (that is, ϕᵣ(x,y)) of reference light is already known, the component (exp{iϕᵣ(x,y)}) generated on the basis of the phase distribution of reference light is stored in advance in the calculation unit 26, and UᵣUᵣ*=|Uᵣ|² is established. Accordingly, at the calculation unit 26, both sides of the second expression are multiplied with the component (exp{iϕᵣ(x,y)}) which is generated on the basis of the phase term of reference light, whereby spatial carrier-eliminated image data from which the spatial carrier component (exp{−iϕᵣ(x,y)}) has been eliminated can be generated.

In the aforementioned embodiment, the component (exp{iϕᵣ(x,y)}) which is generated due to the phase distribution (ϕᵣ(x, y)) of reference light is used as reference light information to be stored in advance in the calculation unit 26, and the case where the component is stored in advance in the calculation unit 26 has been described. However, the present invention is not limited thereto. As reference light information to be stored in advance in the calculation unit 26, various kinds of reference light information may be used as long as both sides of the second expression can be multiplied with the component (exp{iϕᵣ(x,y)}) generated due to the phase distribution of reference light. For example, the phase distribution (ϕᵣ(x, y)) of reference light or the inverse thereof, etc. may be stored in advance as the reference light information in the calculation unit 26. In this case, the calculation unit 26 obtains, on the basis of the reference light information stored therein in advance, the component (exp{iϕᵣ(x,y)}) generated due to the phase distribution of reference light, and multiplies both sides of the second expression with the component.

Specifically, when both sides of the first expression are multiplied with the component (exp{ϕᵣ (x,y)}) generated due to reference light, I(x,y)(exp{iϕᵣ(x,y)})=(|Uₒ(x,y)|²+|Uᵣ (x,y)|²)(exp{iϕᵣ (x,y)})+Uₒ (x, y) Aᵣ (x, y)+Uₒ (x, y)*Aᵣ(x,y) (exp{2iϕᵣ(x, y)}), which is the spatial-carrier eliminated image data.

Note that even when, in the hologram image data, the respective inclination angles of reference light of the wavelengths λ1, λ2, λ3, differ from one another and the respective components (exp{iϕᵣ(x,y)}) generated due to the phase distribution of reference light of the wavelengths λ1, λ2, λ3 differ from one another, for example, the spatial carrier component (exp{−iϕᵣ(x,y)}) included in an object light component of a wavelength to be extracted may be eliminated, so that only object light of a desired wavelength can be left non-subjected to modulation by the phase distribution of reference light.

Accordingly, the calculation unit 26 multiplies, the light intensity component I_{λ} (x, y) of the hologram image data for each wavelength λ with the component (exp{iϕᵣ(x,y)}) generated due to the phase distribution of reference light which is predetermined by the wavelength and angle of the reference light, and thereby, generates spatial carrier-eliminated image data from which the spatial carrier component (exp{−iϕᵣ(x,y)}) phase-modulating the object light has been eliminated for each wavelength from hologram image data. Then, the procedure proceeds to next step SP3 (FIG. 3)

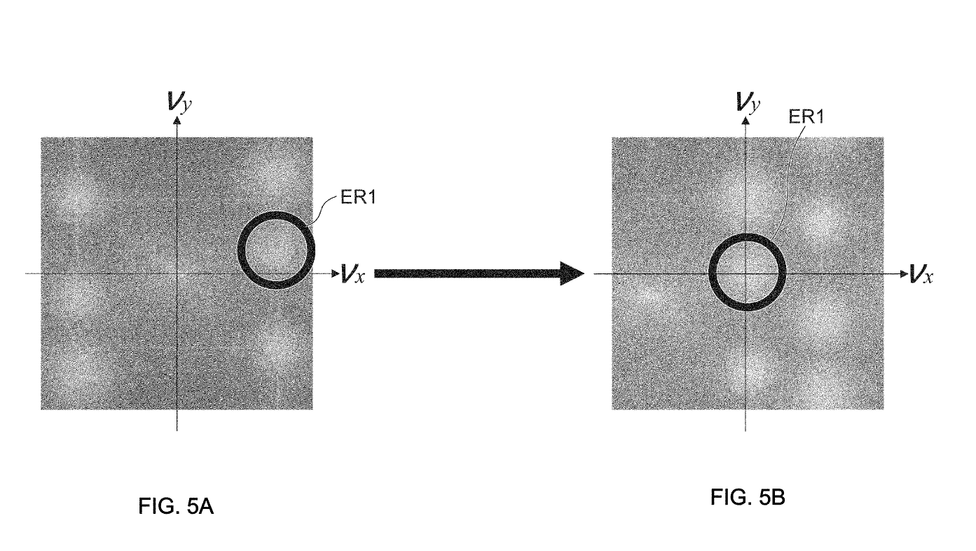

Here, how a spatial frequency component of object light changes according to whether or not the hologram image data is subjected to modulation by a spatial carrier component, is additionally described with use of spatial frequency distribution images shown in FIGS. 5A and 5B. FIG. 5A shows a spatial frequency distribution image obtained by performing two-dimensional Fourier transform on the hologram image data from which before a spatial carrier component (exp{−iϕᵣ(x,y)}) is eliminated. In FIG. 5A, a bright circular region indicates information about object light of certain wavelengths and a conjugate image. The inclination angle/direction of reference light of certain wavelengths is changed, whereby the hologram image data can be recorded as an image such that spatial spectra of the object light of the wavelengths can be split on the spatial frequency distribution image plane. In this case, in the spatial frequency distribution image shown in FIG. 5A, for example, a spatial spectrum of object light appears in a region ER1, and the spatial spectrum of object light is positioned in a high spatial frequency region.

In contrast, FIG. 5B shows a spatial frequency distribution image obtained by performing two-dimensional Fourier transform on the hologram image data from which a spatial carrier component has been eliminated. The spatial spectrum of the object light in the region ER1, which is positioned in the high spatial frequency region in FIG. 5A, is shifted to be distributed with the origin (Vₓ, V_{y})=(0, 0) set as the center thereof. In the spatial frequency distribution image obtained when a spatial carrier component has been eliminated, spatial spectra of any other unnecessary components are shifted but are distributed in the high spatial frequency region.

As described above, when a spatial carrier component corresponding to a desired wavelength is eliminated from hologram image data, a spatial spectrum of a desired object light is shifted to a low spatial frequency region, that is an area near the origin (Vₓ, V_{y})=(0, 0) while spatial spectrum of any other unnecessary light components are distributed in the high spatial frequency region. Here, a smoothing filter for carrying out an average value process on an image on a spatial plane is considered. Since such a smoothing filter has an effect similar to that of a low pass filter, the smoothing filter is considered to be able to extract a spatial spectrum of a desired object light. Thus, at step SP3 and step SP4, the reproduction image generation unit 27 executes, a prescribed number of times, an average value process (described later) the spatial-carrier eliminated image data generated by the calculation unit 26, as shown in FIG. 3, whereby the hologram reproduction image data from which the desired spatial spectrum of the object light has been extracted is generated.

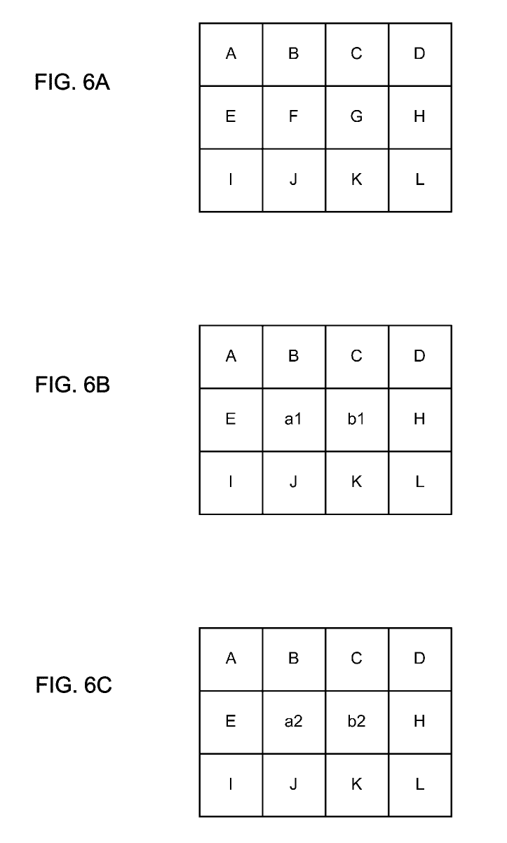

Here a description is given of the average value process to be executed on spatial-carrier eliminated image data consisting of 12 pixels in total including four rows of three vertically arranged pixels, as shown in FIG. 6A, for example. In this case, the reproduction image generation unit 27 specifies center pixels F, G, which are surrounded by pixels, within a spatial-carrier eliminated image generated from spatial-carrier eliminated image data, and executes the average value process on the center pixels F, G. Specifically, in the average value process, the reproduction image generation unit 27 calculates the sum of the center pixel F and surrounding pixels A, B, C, E, G, I, J, K adjacent to the center pixel F, divides the sum by the number “9” of the summed pixels so as to generate an average value pixel a1 (a1=(A+B+C+E+F+G+I+J+K)/9), and replaces the center pixel F with the average value pixel a1, as shown in FIG. 6B.

Also for the other center image G, in the average value process, the reproduction image generation unit 27 similarly calculates the sum of the center pixel G and surrounding pixels B, C, D, F, H, J, K, L adjacent to the center pixel G, divides the sum by the number “9” of the summed pixels so as to generate an average value pixel b1 (b1=(B+C+D+F+G+H+J+K+L)/9), and replaces the center pixel G with the average value pixel b1, as shown in FIG. 6B. By executing the average value process in this way, the reproduction image generation unit 27 replaces the center pixels F, G with the average value pixels (also referred to as high frequency component-eliminated pixels) a1, b1, respectively, by averaging the center pixels F, G so as to eliminate high-frequency components, and thereby, generates the hologram reproduction image data. After generating the hologram reproduction image data by replacing the center pixels F, G with the average value pixels a1, b1, the reproduction image generation unit 27 further executes the average value process on the hologram reproduction image data.

That is, in the average value process, the reproduction image generation unit 27 calculates the sum of the average value pixel a1 and the surrounding pixels A, B, C, E, G, I, J, K adjacent to the average value pixel a1, divides the sum by the number “9” of the summed pixels so as to generate an average value pixel a2 (a2=(A+B+C+E+a1+G+I+J+K)/9), and replaces the average value pixel a1 with the new average value pixel a2, as shown in FIG. 6C.

Also for the other average value pixel b1, in the average value process, the reproduction image generation unit 27 similarly calculates the sum of the average value pixel b1 and the surrounding pixels B, C, D, F, H, J, K, L adjacent to the average pixel b1, divides the sum by the number “9” of the summed pixels so as to generate an average value pixel b2 (b2=(B+C+D+F+b1+H+J+K+L)/9), and replaces the average value pixel b1 with the new average value pixel b2, as shown in FIG. 6C. The reproduction image generation unit 27 repeats the average value process a preset number of times (step SP3, step SP4) so as to generate final hologram reproduction image data. When the number of pixels is 9 and arithmetic mean values are used, the number of executions of the average value process is preferably 1 to 10.

Proceeding to step SP5 (FIG. 3), the control unit 22 generates an object image and a phase image, which indicates the height distribution of the object, on the basis of the finally generated hologram reproduction image data, displays the object image and the phase image on the display unit 25, and ends the reproduction process (step SP6).

Here, at step SP2, I(x, y)(exp{iϕᵣ(x,y)})=(|Uₒ(x,y)|²+|Uᵣ(x,y)|²)(exp{iϕᵣ(x,y)})+Uₒ(x,y)Aᵣ(x,y)+Uₒ(x, y)*Aᵣ(x,y)(exp{2iϕᵣ(x,y)}) is obtained as the spatial carrier-eliminated image data as described above. At step SP3, when the aforementioned average value process is executed on a real part and an imaginary part of this function, f(Re[I(x, y) (exp{iϕᵣ(x,y)}])=Re[Uₒ(x,y) Aᵣ(x,y)] and f(Im[I(x, y) (exp{iϕᵣ(x,y)}])=Im [Uₒ(x,y)Aᵣ(x,y)] are obtained. Note that f( ) represents the average value process, Re represents a real part, and Im represents an imaginary part.

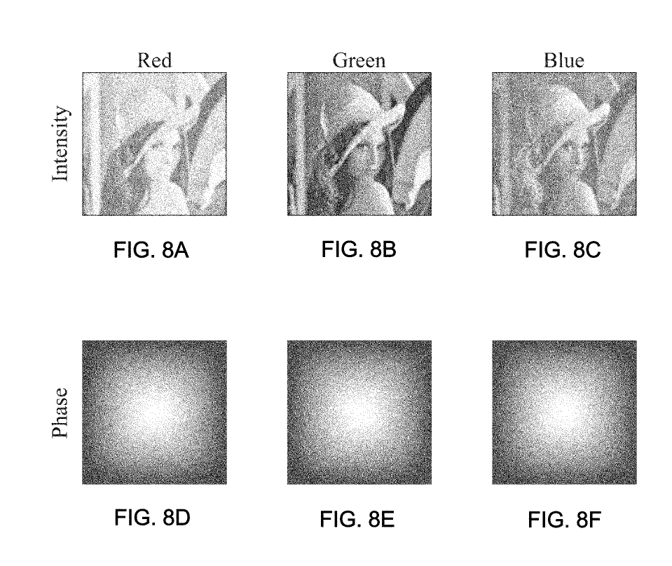

Aᵣ(x, y) may be used as it is, to serve as a constant item. Alternatively, Aᵣ(x, y) may be obtained in advance by recording of the light intensity, which is a squared term of an amplitude, prior to measurement of the object. The reproduction image generation unit 27 can reproduce object images (amplitude images) shown in FIGS. 8A to 8C (described later), for example, by obtaining the amplitudes of object light on the basis of Re[Uₒ(x,y)Aᵣ(x,y)] and Im[Uₒ(x,y)Aᵣ(x,y)] thus obtained. Moreover, the reproduction image generation unit 27 can also obtain the phase distribution of the object on the basis of Re[Uₒ(x,y)Aᵣ(x,y)] and Im [Uₒ(x, y) Aᵣ (x,y)], and thus, also can reproduce phase images indicating the phase distributions of the object shown in FIGS. 8D to 8F (described later).

As described above, the image reproduction device 17 can reproduce an object image or a phase image thereof from hologram image data by executing the spatial carrier eliminating process and the average value process without performing a conventional calculation process such as two-dimensional Fourier transform or two-dimensional inverse Fourier transform.

### (3) Simulations

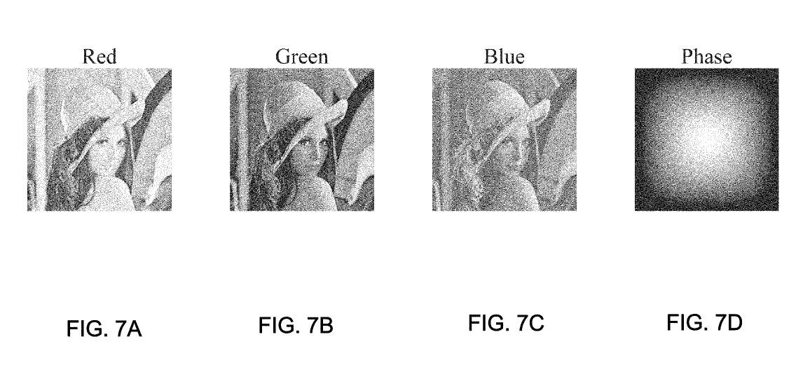

Next, a description is given of simulation results of the image reproduction process executed by the image reproduction device 17 according to the present invention. Here, it is assumed that the image reproduction device 17 illustrated in FIG. 2 was used. First, a simulation was carried out as to selective extraction of a specific spatial frequency band through the average value process. A wavelength-multiplexed image hologram was assumed to be obtained with use of an imaging element having the number of pixels 512×512 and a pixel interval of 5 μm and of three lasers which oscillate lights of three wavelengths of 640 nm, 532 nm, and 473 nm. Simulation images shown in FIGS. 7A to 7C was generated in a computing machine, and the image reproduction process according to the present invention was executed using these simulation images.

FIG. 7A is a simulation image indicating an amplitude distribution expressing the brightness of an object in red (wavelength: 640 nm). FIG. 7B is a simulation image indicating an amplitude distribution expressing the brightness of the object in green (wavelength: 532 nm). FIG. 7C is a simulation image indicating an amplitude distribution expressing the brightness of the object in blue (wavelength: 473 nm). A portrait of a woman was used as the object. FIG. 7D is an image indicating the height (depth dimension) distribution of the object obtained by synthesizing the three colors RGB, and shows the height of the object in bright-dark gradation where a brighter portion represents a higher portion (on the front side) and a darker portion represents a lower portion (on the rear side).

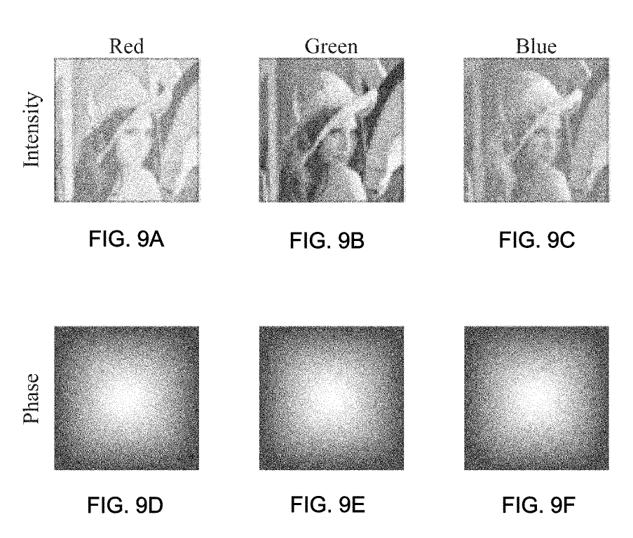

Mean filtering of calculating and outputting the average value of nine pixels in each of the simulation images in FIGS. 7A to 7C, in such a manner shown in FIGS. 6A to 6C, was calculated five times or ten times. The results of five times and ten times of execution of the average value process were checked, so that results shown in FIGS. 8A to 8C and results shown in FIGS. 9A to 9C were obtained, respectively. FIG. 8A is an image obtained by carrying out, five times, mean filtering of calculating and outputting the average value of nine pixels in the simulation image in FIG. 7A. FIG. 8B is an image obtained by carrying out, five times, mean filtering of calculating and outputting the average value of nine pixels in the simulation image in FIG. 7B. FIG. 8C is an image obtained by carrying out, five times, mean filtering of calculating and outputting the average value of nine pixels in the simulation image in FIG. 7C.

From the results in FIGS. 8A to 8C, an object image the same as the object image in the simulation images in FIGS. 7A to 7C was visually recognized with clearness at each of the wavelengths. Accordingly, reproduction of the object image in the simulation images in FIGS. 7A to 7C was confirmed to succeed even after the five times of mean filtering. In addition, images each indicating an object height (depth dimension) distribution obtained when mean filtering was carried out five times were also checked, and the results shown in FIGS. 8D to 8F were obtained. Thus, reproduction of phase images was confirmed to succeed. FIG. 8D is a phase image of FIG. 8A. FIG. 8E is a phase image of FIG. 8B. FIG. 8F is a phase image of FIG. 8C.

Moreover, FIG. 9A is an image obtained by carrying out, ten times, mean filtering of calculating and outputting the average value of nine pixels in the simulation image in FIG. 7A. FIG. 9B is an image obtained by carrying out, ten times, mean filtering of calculating and outputting the average value of nine pixels in the simulation image in FIG. 7B. FIG. 9C is an image obtained by carrying out, ten times, mean filtering of calculating and outputting the average value of nine pixels in the simulation image in FIG. 7C.

From the results in FIGS. 9A to 9C, an object image the same as the object image in the simulation images in FIGS. 7A to 7C was visually recognized with clearness at each of the wavelengths even when mean filtering was carried out ten times. Accordingly, reproduction of the object image in the simulation images in FIG. 7A to 7C was confirmed to succeed even after mean filtering was carried out ten times. In addition, images each indicating an object height (depth dimension) distribution obtained when mean filtering was carried out ten times were also checked, and the results shown in FIGS. 9D to 9F were obtained. Reproduction of the phase images was also confirmed to succeed. FIG. 9D is a phase image of FIG. 9A. FIG. 9E is a phase image of FIG. 9B. FIG. 9F is a phase image of FIG. 9C.

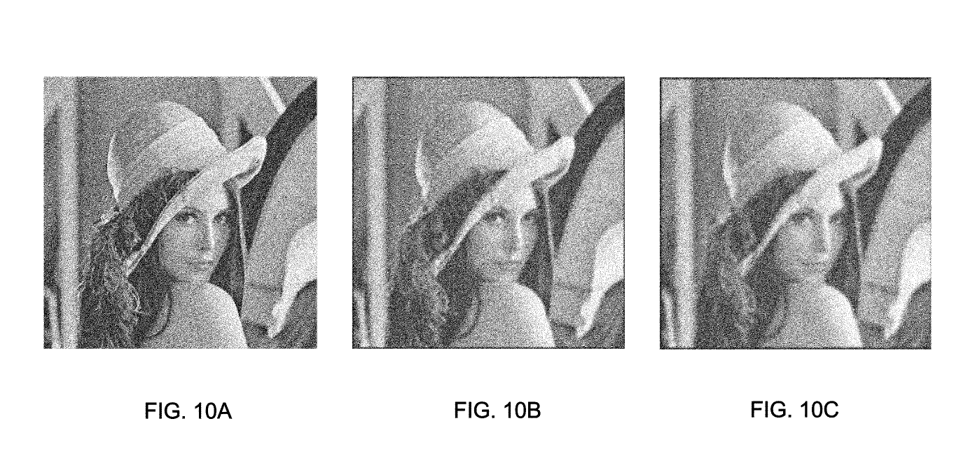

Here, FIG. 10A is a color synthetic simulation image obtained by synthesizing the simulation images in FIGS. 7A to 7C. FIG. 10B is a color synthetic image obtained by synthesizing the images in FIGS. 8A to 8C. FIG. 100 is a color synthetic image obtained by synthesizing the images in FIGS. 9A to 9C. From the result shown in FIG. 10B, reproduction of the color image very similar to the simulation image in FIG. 10A was confirmed to succeed even after the mean filtering was carried out five times. In addition, from the result in FIG. 100, reproduction of the color image very similar to the simulation image in FIG. 10A was confirmed to succeed even after the mean filtering was carried out ten times.

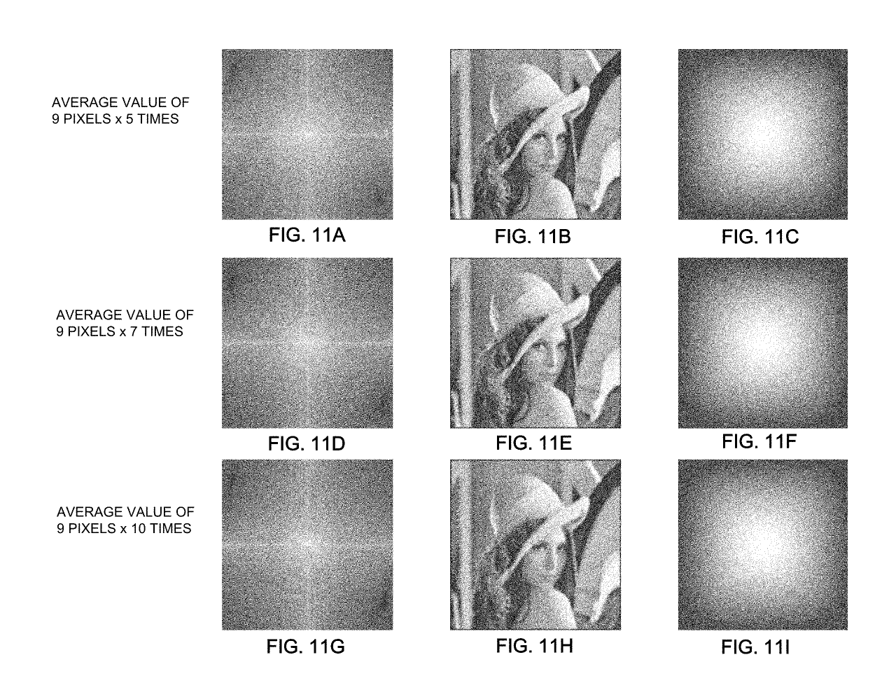

Next, the simulation result obtained by the seven times of mean filtering of calculating and outputting the average value of nine pixels in each of the simulation images, was compared with the simulation result obtained by the five times of the aforementioned mean filtering and with the simulation result obtained by the ten times of the aforementioned mean filtering, while these results were shown side by side. Here, FIG. 11A is a spatial frequency distribution image obtained by performing Fourier transform on the image in FIG. 11B, which was subjected to the five times of the mean filtering. FIG. 11D is a spatial frequency distribution image obtained by performing Fourier transform on the image in FIG. 11E, which was subjected to the seven times of the mean filtering. FIG. 11G is a spatial frequency distribution image obtained by performing Fourier transform on the image in FIG. 11H, which was subjected to the ten times of the mean filtering. From FIGS. 11A, 11D, and 11G, it was confirmed that, after Fourier transform was performed on the images subjected to the average value process, components other than the spatial spectrum of a desired object light wave had been eliminated.

Also, FIG. 11B is a synthetic image obtained by color synthesis after the five times of the mean filtering. FIG. 11E is a synthetic image obtained by color synthesis after the seven times of the mean filtering. FIG. 11H is a synthetic image obtained by color synthesis after the ten times of the mean filtering. From the result in FIG. 11E, reproduction of a color image very similar to the simulation image (FIG. 10A) was confirmed to succeed even after the seven times of the mean filtering. Moreover, from the results in FIG. 11B, FIG. 11E, and FIG. 11H, it was confirmed that while reproduction of an object image the same as a simulation image succeeded, the contour of the object image became more blurred as the number of times of execution of the mean filtering increased.

Images indicating object height (depth dimension) distributions obtained when mean filtering was carried out five times, seven times, and ten times were also checked, and the results shown in FIG. 11C, FIG. 11F, and FIG. 11I were obtained. It was confirmed that no significant difference occurred among the reproduced phase images. Note that FIG. 11C is a phase image of FIG. 11B, FIG. 11F is a phase image of FIG. 11E, and FIG. 11I is a phase image of FIG. 11H.

As described above, it was confirmed that the image reproduction device 17 according to the present invention can reproduce an object image and a phase image the same as a simulation image, without using conventional two-dimensional Fourier transform or two-dimensional inverse Fourier transform. In addition, it was also confirmed that extraction of two desired kinds of object light succeeded even when the mean filtering was carried out one time on a hologram obtained by wavelength multiplexing using light of two wavelengths. For a specific computer machine simulation procedure, an assumed recording condition was that, when the pixel interval was defined as d, the spatial spectra of two kinds of object light, two kinds of conjugate images, and a 0th-order diffraction light were separated by either ±1/(4 d) or ±1/(2 d) in the vertical or horizontal direction on a spatial frequency plane of the hologram. Here, when a 4×4-pixel mean filter of the present invention was applied, light wave components other than those of desired object light were efficiently eliminated. It is similarly considered that, when any of various types of P×P-pixel (P is a natural number) filters is used, a light wave component separated by ±Q/(Pd) (Q is an integer other than 0) can be efficiently eliminated by use of a zero point (a zero point refers to a point at which the spectrum value on a frequency plane is 0. For example, when a P-pixel mean filter is used, the spectrum value at integer times of the frequency 1/P is 0 so that a zero point appears at the integer times of the frequency 1/P). Various types of PxR-pixel or RxP-pixel filters may be used while P≠R (R is a natural number).

### (4) Operations and Effects

With the aforementioned configuration, the image reproduction device 17 acquires, through the data acquisition unit 23, hologram image data formed of object light of multiple wavelengths from an object and reference light of the wavelengths applied at a prescribed angle with respect to the object light. In the image reproduction device 17, the calculation unit 26 stores therein in advance a component (exp{ϕᵣ (x,y)}) generated due to a phase distribution of reference light predetermined by the wavelength and the angle of the reference light, and the calculation unit 26 multiplies, on a wavelength basis, a light intensity component of hologram image data with the component generated due to the phase distribution of the reference light. As a result, the image reproduction device 17 eliminates a spatial carrier component which generates the phase distribution of the reference light and which phase-modulates an object light from the hologram image data, on a wavelength basis, and thereby, generates spatial carrier-eliminated image data.

Further, in the image reproduction device 17, the reproduction image generation unit 27 executes the average value process of replacing a pixel included spatial-carrier eliminated image data with an average value image (a high frequency component-eliminated pixel) which is generated by obtaining the average value of a prescribed number of pixels surrounding the concerned pixel, whereby hologram reproduction image data is generated. Regarding the hologram reproduction image data which is obtained by performing the average value process on a real part and an imaginary part of a function about the spatial-carrier eliminated image data, the amplitude image (object image) of object light and a phase image of the object can be reproduced from a real part (Re[Uₒ(x,y)Aᵣ(x,y)]) and an imaginary part (Im[Uₒ(x,y)Aᵣ(x,y)]) of a function about the hologram reproduction image data.

As described above, the image reproduction device 17 can reproduce an object image or a phase image thereof from hologram image data without performing conventional two-dimensional Fourier transform or two-dimensional inverse Fourier transform. Since no two-dimensional Fourier transform or no two-dimensional inverse Fourier transform is performed, the calculation loads can be accordingly reduced and a time required to reproduce an object image from hologram image data can be shortened, compared with a conventional technology. The computer machine simulations which were carried out with use of an image hologram have been described herein. However, the present invention is also applicable to an optical system having no image forming lens. The present invention is expected to aggressively facilitate real time display of a color holographic image, in application to a holographic display for optically reproducing a three-dimensional image of an object from a wavelength-multiplexed hologram, for example.

### (5) Other Embodiments

### (5-1) Other Embodiments of Average Value Process

Note that the present invention is not limited to the aforementioned embodiment, and various modifications can be made within the scope of the gist of the present invention. For example, in the aforementioned embodiment, the case where, in the average value process for performing average value conversion on a target pixel, the average value (for example, a1=(A+B+C+E+F+G+I+J+K)/9) of nine pixels including the target pixel F and eight pixels A, B, C, E, G, I, J, K surrounding the target pixel F are obtained to be set as the average value image (high frequency-eliminated pixel) a1 and the target pixel F is replaced with the average value image a1, has been described. However, the average value process in which the present invention is not limited thereto. For example, the average value process may be applied in which the average value of two pixels including a target pixel and one or more surrounding the target pixel is obtained to be set as an average value pixel, and the target pixel is replaced with the average value pixel.

In addition, for example, in the average value process according to another embodiment, the average value (for example, a1=(F+B+J+E+G)/5) of five pixels including the target pixel F in FIG. 6A and four pixels B, J, E, G positioned in a cross shape centered on the target pixel F, or the average value (for example, a1=(F+A+K+C+I)/5) of five pixels including the target pixel F and four pixels A, K, C, I positioned in an x shape centered on the target pixel F may be obtained to be set as a high frequency-eliminated pixel a1, and the target pixel F may be replaced with the high frequency-eliminated pixel a1.

Alternatively, in another average value process, the average value (for example, a1=(F+A+K)/3) of the target pixel F and two pixels (for example, the pixels A, K, the pixels A, B, the pixels I, G, etc.) each adjacent to the target pixel F, or the average value (for example, a1=(F+A+K+G)/4) of the target pixel F and three pixels (for example, pixels A, K, G, pixels A, B, C, or pixels I, G, A) may be obtained to be set as the high frequency-eliminated pixel a1, and may be replaced with the target pixel F. Also, not all the pixels used for obtaining the average value concerning the target pixel F do not need to be adjacent to the target pixel F. Such pixels only need to be positioned in the surrounding area of the target pixel F. In such an average value process, the average value (for example, a1=(F+A+D+I+L)/5) of the target pixel F and four pixels A, D, I, L in the surrounding area of the target pixel F may be obtained, for example, to be set as the high frequency-eliminated pixel a1 and target pixel F may be replaced with the high frequency-eliminated pixel a1.

Furthermore, the process for generating the high frequency-eliminated pixel does not need to be the average value process, and may be a weighting process using a sinc function, for example. In this case, a high frequency-eliminated pixel is generated by use of a sinc function in which the center target pixel F, rather than eight pixels A, B, C, E, G, I, J, K surrounding the target pixel F, is weighted. Specifically, a1={Fsinc(0)+(B+E+G+J)sinc(mπ)+(A+C+I+K)sinc(nπ)}/9 wherein m=½ and n=(2)^{1/2}/2, or a1={Fsinc(0)+(B+E+G+J)sinc(mπ)+(A+C+I+K)sinc²(mπ)}/9 wherein m=⅓, or a1={Fsinc(0)+(B+E+G+J)sinc(1)+(A+C+I+K)sinc²(1)}/9, etc. may be used. Thus, specific examples of the weighting process include a process of using the sinc function and executing a smoothing process while changing the weight according to the distance from the target pixel. In addition, the values m, n may be real numbers other than the aforementioned values, and the weight for each pixel may be based on the distance to the target pixel. A Bessel function or a high order function such as a quadratic function or a quartic function may be used instead of the sinc function.

### (5-2) Reproduction Process Including Fourier Transform Process

In the aforementioned embodiment, the case where the average value process or the weighting process are performed on the spatial carrier-eliminated image data with use of the preset number of pixels, has been described. However, the present invention is not limited thereto. A Fourier transform process may be executed on hologram image data such that spatial frequency distribution image data is obtained, and the magnitude of the spatial spectrum of object light in a spatial frequency distribution image based on the spatial frequency distribution image data may be specified, and the number of pixels for use in the average value process or the weighting process may be determined according to the magnitude of the spatial spectrum.

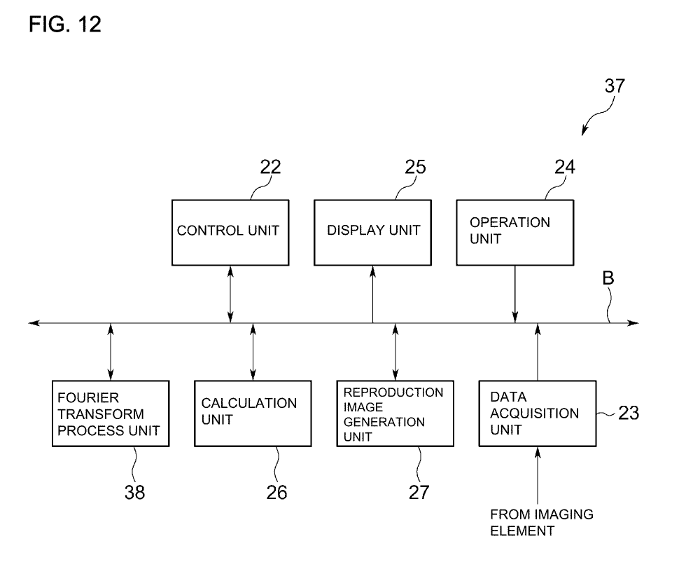

In this case, in an image reproduction device 37 provided to the digital holography device 1 (FIG. 1), a Fourier transform process unit 38 is connected to the control unit 22, etc. via the bus B, as illustrated in FIG. 12. The image reproduction device 37 sends, to the Fourier transform process unit 38, hologram image data acquired through the data acquisition unit 23. The Fourier transform process unit 38 generates spatial frequency distribution image data by executing the two-dimensional Fourier transform process on the hologram image data. The Fourier transform process unit 38 causes the display unit 25 to display a spatial frequency distribution image based on the spatial frequency distribution image data, for example, and specifies the spatial spectrum of object light in the spatial frequency distribution image through image processing, so that the magnitude of the spatial spectrum can be measured. Further, the Fourier transform process unit 38 specifies the number of pixels corresponding to the same size as the inverse of the magnitude of the spatial spectrum of the object light on the spatial frequency distribution image, determines the number of pixels as one calculation pixel, and sends, to reproduction image generation unit 27, the one calculation pixel as the calculation data about the number of pixels.

When a pixel interval is defined as d, the width of a spatial spectrum recordable by an imaging element is expressed by the inverse (1/d) of the pixel interval d. Accordingly, if the width of the spatial spectrum of object light on the spatial frequency distribution image is equal to the inverse (1/(4 d)) of the magnitude of four adjacent pixels, for example, the Fourier transform process unit 38 determines, as one calculation pixel, four pixels adjacent to each other with respect to a direction of the width, and sends the one calculation pixel as calculation data about the number of pixels to the reproduction image generation unit 27.

Thereafter, the reproduction image generation unit 27 receives the spatial carrier-eliminated image data generated by the calculation unit 26, and executes the average value process or the weighting process on spatial carrier-eliminated image data on a calculation pixel basis and in accordance with the calculation data about the number of pixels. Here, for example, when calculation data about the number of pixels in which four adjacent pixels are determined as one calculation pixel, is received by the reproduction image generation unit 27 from the Fourier transform process unit 38, the reproduction image generation unit 27 executes the average value process by using four adjacent pixels as one calculation pixel.

From a real part and an imaginary part of a function obtained through the average value process or the weighting process, the reproduction image generation unit 27 can obtain the amplitude of the object light, and thereby, reproduce an object image, and can also obtain an object phase distribution, and thereby, also reproduce a phase image of the object.

With the aforementioned configuration, the image reproduction device 37 performs Fourier transform on hologram image data in the image reproduction process, but does not perform conventional two-dimensional inverse Fourier transform which is performed the number of times corresponding to the number of wavelengths. Accordingly, the calculation load can be reduced and a time required to reproduce an object image from hologram image data can be shortened, compared with the conventional technology.

### (5-3) Still Other Embodiments

In the aforementioned embodiment, the case where the hologram image data is applied which is generated by use of, as the multiple kinds of object light and reference light, object light and reference light of multiple wavelengths, has been described. However, the present invention is not limited thereto. Hologram image data may be applied which is generated by use of object light and reference light in multiple polarized states, object light and reference light which take multiple time periods to reach the image capturing surface of the imaging element 12, or object light and reference light having multiple height sensitivities depending on multiple illumination angles, for example.

In addition, in the aforementioned embodiment, the case has been described where, as the calculation unit, a calculation unit that stores in advance the component (exp{iϕᵣ(x,y)}) generated due to the phase distribution of reference light predetermined by the wavelength and angle of the reference light and that eliminates a spatial carrier component from hologram image data by multiplying a light intensity component of the hologram image data by the component (exp{iϕᵣ(x,y)}) generated due to the phase distribution of the reference light, is provided. The present invention is not limited thereto. For example, the inverse (1/(exp{ϕᵣ (x,y)})) of a component generated due to the phase distribution of the reference light which is predetermined by the wavelength and the angle of reference light, may be stored as reference light information, and a calculation unit that eliminates a spatial carrier component from the hologram image data by dividing a light intensity component of the hologram image data by the inverse (1/(exp{ϕᵣ (x,y)})) of the component generated due to the phase distribution of the reference light, may be applied.

Even in this case, as the reference light information to be stored in advance in the calculation unit 26, various kinds of reference light information may be used as long as both sides of the aforementioned second expression can be divided by the inverse (1/(exp{ϕᵣ (x,y)})) of a component generated due to the phase distribution of the reference light. For example, the phase distribution (ϕᵣ(x,y)) of reference light or the component (exp{ϕᵣ (x,y)}) generated due to the phase distribution of reference light, etc. can be stored as the reference light information in the calculation unit 26. In this case, the calculation unit 26 obtains the inverse of a component generated due to the phase distribution of reference light on the basis of the reference light information stored in advance, and divides both sides of the aforementioned second expression with the inverse, whereby the same effects as those in the aforementioned embodiment can be provided.

### REFERENCE SIGNS LIST

1 digital holography device
17, 37 image reproduction device
23 data acquisition unit
26 calculation unit
27 reproduction image generation unit
38 Fourier transform process unit

1. An image reproduction device of reproducing hologram image data formed of object light from an object and of reference light applied at a prescribed angle with respect to the object light, the device characterized by comprising:
a calculation unit that generates spatial carrier-eliminated image data by eliminating a spatial carrier component, which is generated due to a phase distribution of the reference light and which phase-modulates the object light, from the hologram image data through calculation; and
a reproduction image generation unit that generates hologram reproduction image data by replacing one or more target pixels included in the spatial carrier-eliminated image data with high frequency component-eliminated pixels obtained by average value conversion or weighting using a prescribed number of pixels.

2. The image reproduction device according to claim 1, characterized in that
the calculation unit eliminates the spatial carrier component from the hologram image data by multiplying a light intensity component of the hologram image data with a component which is generated due to a phase distribution of the reference light predetermined by a wavelength and an angle of the reference light.

3. The image reproduction device according to claim 1, characterized in that
the calculation unit eliminates the spatial carrier component from the hologram image data by dividing a light intensity component of the hologram image data by an inverse of a component which is generated due to a phase distribution of the reference light predetermined by a wavelength and an angle of the reference light.

4. The image reproduction device according to claim 1, characterized in that
after generating the high frequency component-eliminated pixel, the reproduction image generation unit further replaces the high frequency component-eliminated pixel with a new high frequency component-eliminated pixel obtained by average value conversion or weighting using a prescribed number of pixels.

5. The image reproduction device according to claim 1, characterized in that
the reproduction image generation unit generates the high frequency component-eliminated pixel by specifying, as a target pixel, a pixel surrounded by pixels in the spatial carrier-eliminated image data, and by average value conversion or weighting using the pixels surrounding the target pixel.

6. The image reproduction device according to claim 1, characterized by comprising a Fourier transform process unit that generates spatial frequency distribution image data by executing a Fourier transform process on the hologram image data, and specifies a magnitude of a spatial spectrum of the object light from the spatial frequency distribution image data, wherein
the reproduction image generation unit determines the number of pixels for generating the high frequency component-eliminated pixel in accordance with the magnitude of the spatial spectrum of the object light specified by the Fourier transform process unit.

7. The image reproduction device according to claim 1, characterized in that
the object light and the reference light are of multiple kinds, and
the calculation unit generates the spatial carrier-eliminated image data by eliminating the spatial carrier component from the hologram image data on the kind basis through calculation.

8. An image reproduction method of reproducing hologram image data formed of object light from an object and of reference light applied at a prescribed angle with respect to the object light, the method characterized by comprising:
a calculation step of generating spatial carrier-eliminated image data by eliminating a spatial carrier component, which is generated due to a phase distribution of the reference light and which phase-modulates the object light, from the hologram image data through calculation that is executed by a calculation unit; and
a reproduction image generating step of generating hologram reproduction image data by replacing, by means of a reproduction image generation unit, one or more target pixels included in the spatial carrier-eliminated image data with high frequency component-eliminated pixels obtained by average value conversion or weighting using a prescribed number of pixels.

9. A digital holography device of recording, as hologram image data, an interference pattern that is formed of object light from an object and of reference light applied at a prescribed angle with respect to the object light by means of an imaging element, the interference pattern being obtained by applying the object light and the reference light to an image capturing surface of the imaging element, the digital holography device characterized in that
the imaging element transmits the hologram image data to the image reproduction device according to claim 1.
